(19) United States
(12) Patent Application Publication
(10) Pub. No.: US 2026/0038986 A1
(43) Pub. Date: Feb. 5, 2026

(54) BATTERY CELL MANUFACTURING METHOD AND BATTERY CELL

(71) Applicant: MAZDA MOTOR CORPORATION, Hiroshima (JP)

(72) Inventor: Takanori KAJIMOTO, Aki-gun (JP)

(73) Assignee: MAZDA MOTOR CORPORATION, Hiroshima (JP)

(21) Appl. No.: 19/274,671

(22) Filed: Jul. 21, 2025

(30) Foreign Application Priority Data
Aug. 2, 2024 (JP) 2024-127920

(51) Int. Cl. H01M 50/536; H01M 10/04; H01M 50/105; H01M 50/54

(52) U.S. Cl. CPC H01M 50/536; H01M 10/0468; H01M 50/105; H01M 50/54

(57) ABSTRACT

A method of manufacturing a battery cell includes layering electrode sheets in a layering direction. The electrode sheets each have an electrode placed in a container and a current collector that is connected to the electrode in the container and protrudes to the outside through an opening of the container. The method also includes applying pressure and heat to a resin placed between the current collector and the current collector layered on each other from outer sides toward a center in the layering direction. The melted resin is caused to flow through a through hole formed in the current collector in the layering direction and fill the through hole. The resin is welded between the current collector and the current collector and sealing the opening of the container.

### CROSS-REFERENCE TO RELATED APPLICATION

The present application claims priority to Japanese application number 2024-127920, filed in the Japanese Patent Office on Aug. 2, 2024, the entire contents of which are incorporated herein by reference.

### TECHNICAL FIELD

The technology disclosed herein relates to a battery cell manufacturing method and a battery cell.

### BACKGROUND ART

The conventional laminated battery is a battery in which an electrode body is housed in an exterior member. The conventional laminated battery includes a plurality of current-collecting terminals extracted from the electrode body to the outside of the exterior member. The plurality of current-collecting terminals are layered with thermoplastic resins interposed therebetween. The thermoplastic resins are welded to the exterior member in the peripheral portion of the exterior member, thereby closing the peripheral portion of the exterior member. In the conventional laminated battery, each of the plurality of current-collecting terminals is extracted to the outside of the exterior member, and the plurality of current-collecting terminals are not connected to each other inside the exterior member. In the conventional laminated battery, the space inside the exterior member can be utilized for enlargement of the electrode body, which is advantageous for improvement in the energy density of the battery.

### SUMMARY

### Problem to be Solved

The conventional laminated battery is manufactured through a heat-sealing process. In the heat-sealing process, thermoplastic resins layered in the peripheral portion of the exterior member are welded to each other by means of hot plates pressed in the layered direction, which serve as an energy supply source.

In this regard, in the case of increasing the current collectors in a battery cell having the same structure as that of the conventional laminated battery, a large number of layered resins need to be welded at the time of manufacturing of the battery cell. In the case where the number of layered resins is large, resins placed near the center in the layering direction are far away from the energy supply source. This entails a risk of insufficient welding of the resins near the center due to insufficient supply of energy to the resins placed near the center.

The technology disclosed herein reduces insufficient welding of the resins at the time of manufacturing of the battery cell.

### Solution to the Problem

The technology disclosed herein relates to a battery cell manufacturing method. The manufacturing includes layering electrode sheets in a layering direction. The electrode sheets each have an electrode placed in a container and a current collector that is connected to the electrode in the container and protrudes outside through an opening of the container. The method includes applying pressure and heat to a resin placed between the current collector of one of the electrode sheets and the current collector of another one of the electrode sheets layered on the one of the electrode sheets from outer sides toward a center in the layering direction. Then the resin is caused to flow through through holes in the current collectors of the one of the electrode sheets and the another one of the electrode sheets in the layering direction and fill the through holes the resin is welded between the current collector of the one of the electrode sheets and the current collector of the another one of the electrode sheets. Then the opening of the container is sealed.

Regarding the battery cell manufactured by this manufacturing method, each of the plurality of current collectors layered on each other protrudes through the opening of the container outside of the container. The plurality of current collectors are connected to the electrodes of the same polarity, for example. Inside the container, the plurality of current collectors are not connected to each other. Connection space for the current collector inside the container is omitted. The electrodes of the battery cell can be enlarged by utilizing the space inside the container. With this, the energy density of the battery cell can be increased.

The opening of the container is sealed by the resin. The resin is, for example, a thermoplastic resin. At the time of manufacturing the battery cell, pressure and heat are applied to the resin placed between the current collector and the current collector layered on each other from the outer sides toward the center in the layering direction. For example, hot plates for applying heat to the resins are placed on the outer sides in the layering direction, and supply thermal energy from the outer sides toward the center. The thermal energy supplied to the resins placed near the center in the layering direction tends to be lower than the thermal energy supplied to the resins placed on the outer sides in the layering direction because of attenuation.

In this regard, the current collectors have the through holes. Melted resins flow in the layering direction through the through holes formed in the current collectors. Since the thermal energy is conducted by the resins flowing from the outer sides toward the center in the layering direction, attenuation of the energy is reduced. In addition, since the melted resins pass through the through holes of the current collectors, the distance of heat transfer is substantially short, and at the same time, the heat transmission paths formed by the resins are not divided by the current collectors but continue from the outer sides toward the center in the layering direction. The resins placed near the center in the layering direction are sufficiently supplied with the thermal energy. All the resins can be sufficiently welded to the current collectors. Insufficient welding of the resins at the time of manufacturing of the battery cell is reduced.

Each of the electrode sheets may have the resin that is bonded in advance on a first surface in the layering direction of the current collector and be free from the resin on a second surface opposite to the first surface in the layering direction, and the resin on the first surface may flow through the through hole to the second surface at the time of application of pressure and heat in the layering direction and be welded to the current collector facing the second surface between the second surface and the current collector.

The electrode sheet has the resin only on one side of the current collector. In the group of electrode sheets layered in the layering direction, the total thickness of the resins is small. Since the distance of heat transfer is short, the thermal energy is sufficiently supplied to even the resins near the center in the layering direction at the time of application of pressure and heat to the resins.

In addition, the resin on the first surface flows through the through holes toward the second surface, and is welded to the current collector facing the second surface between the second surface and the current collector. Although the electrode sheet has the resin only on one side of the current collector, the resin is welded to the current collector on both sides of the current collector and thereby the opening of the container is sealed.

The technology disclosed herein relates to a battery cell. The battery cell includes a container that houses electrodes and a plurality of current collectors that are connected to the electrodes in the container and, in a state of being layered in a layering direction, protrude to the outside of the container through an opening of the container. A resin seals the opening of the container and is welded to the current collectors between layers thereof. The current collectors each have a first surface, a second surface opposite to the first surface in the layering direction and, in a portion interposed between a first resin being in contact with the first surface and a second resin being in contact with the second surface, at least one through hole that penetrates a respective current collector in the layering direction, and an inside of the through hole is filled with a resin that is continuous with each of the first resin and the second resin.

In the battery cell manufactured by the manufacturing method described earlier, the inside of the through hole of the current collector is filled with the resin that is continuous to each of the first resin and the second resin. Insufficient welding of the resins at the time of manufacturing of the battery cell is reduced. The quality of the battery cell is stable.

The current collectors each may have a raised portion rising from an opening edge of the through hole in at least one of the first surface and the second surface, and
the raised portion may be buried in the first resin or the second resin.

The raised portion buried in the first resin or the second resin enhances the strength against separation between the current collector and the resin welded to the current collector, due to an anchoring effect.

The raised portion may be, for example, a burr generated at the time when the through hole is formed in the current collector by machining. The burr generated at the time of machining may, when separated from the current collector, cause a short circuit in electrodes inside the container. In general, burrs are removed from the current collector after the through holes are formed. In contrast, in the battery cell manufacturing method described earlier, the burrs are buried in the resin and therefore do not serve as a contaminant in the battery cell. In the battery cell manufacturing method, a process of removing the burrs can be omitted.

### Advantageous Effects

According to the above-described battery cell manufacturing method and battery cell, insufficient welding of resins at the time of manufacturing of the battery cell can be reduced.

### BRIEF DESCRIPTION OF DRAWINGS

FIG. 1 is a sectional view of a battery cell.

FIG. 2 illustrates part of a procedure for manufacturing an electrode sheet.

FIG. 3 illustrates part of the procedure for manufacturing the electrode sheet.

FIG. 4 is a perspective view illustrating a surface of a current collector in which through holes are formed.

FIG. 5a illustrates a state before welding of resins for sealing an opening portion of a container.

FIG. 5b illustrates a state after welding of the resins.

FIG. 6 is a sectional view illustrating welding interfaces between the current collector and the resins in an enlarged manner.

### DETAILED DESCRIPTION

Hereinafter, embodiments of a battery cell manufacturing method and a battery cell will be described with reference to the drawings. The battery cell manufacturing method and battery cell described herein are merely examples.

### (Structure of Battery Cell)

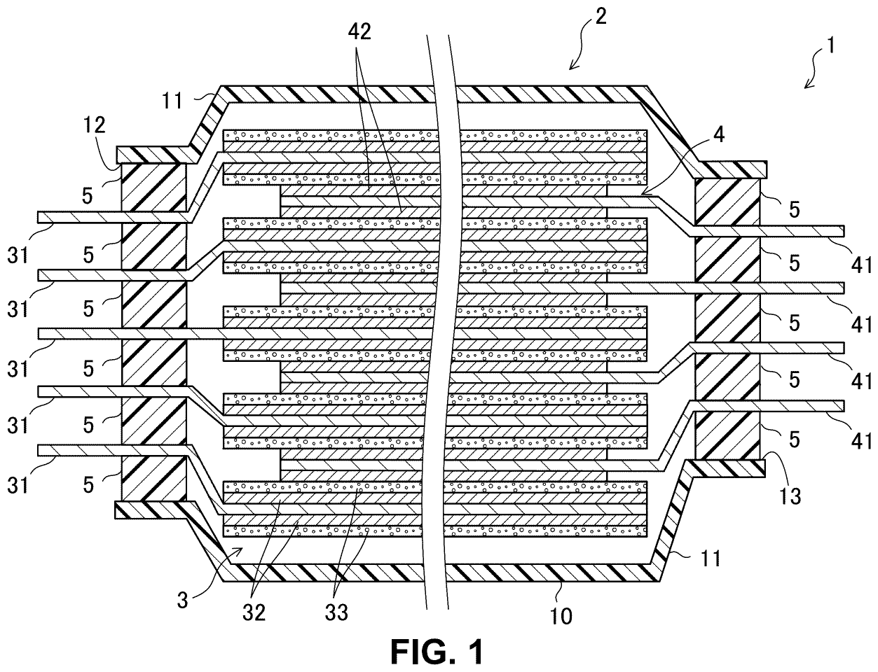

FIG. 1 schematically illustrates a whole structure of a battery cell 1. The battery cell 1 is a secondary battery. The battery cell 1 is, for example, a lithium-ion battery. A container 10 of the battery cell 1 is formed by folding a single laminate material 11 or layering two laminate materials 11 into a bag-like shape. The laminate material 11 has, for example, a three-layered structure in which both sides of a metal layer are interposed between resin layers. The metal layer is, for example, aluminum or stainless steel. The resin layer is, for example, polypropylene (PP) or polyethylene (PE). The container 10 is sealed airtightly in a state where a power generating element 2 and an electrolyte are housed therein. The battery cell 1 is a so-called pouch-type battery.

The power generating element 2 has first electrode sheets 3 and second electrode sheets 4. The first electrode sheets 3 are, for example, negative-electrode sheets. The second electrode sheets 4 are, for example, positive-electrode sheets. The first electrode sheets 3 and the second electrode sheets 4 are alternately layered. The power generating element 2 has any number of first electrode sheets 3 or second electrode sheets 4. The power generating element 2 is an electrode-layered product. Note that, in the following, the direction in which the first electrode sheets 3 and the second electrode sheets 4 are layered on each other may be referred to as a layering direction.

The first electrode sheet 3 has a current collector 31. The current collector 31 a thin plate material or foil extending in a direction orthogonal to the layering direction. A first end portion, that is, the left end portion in FIG. 1 of the current collector 31 protrudes through a first opening 12 of the container 10 to the outside of the container 10.

A first surface and a second surface of the current collector 31 placed inside the container 10 are coated with an active material. The first surface is the upper surface of the current collector 31 in FIG. 1, and the second surface is the lower surface of the current collector 31 in FIG. 1. The active material forms a first electrode 32. The current collector 31 is connected to the first electrode 32.

The first electrode sheet 3 has a separator 33. The separator 33 separates the first electrode 32 of the first electrode sheet 3 and a second electrode 42, which will be described later, of the second electrode sheet 4 from each other. The separator 33 is, for example, a porous material through which an ionic material can permeate. The separator 33 covers the surface of each of the two first electrodes 32 of the first electrode sheet 3. The area of the separator 33 may be larger than the area of the first electrode sheet 3.

The second electrode sheet 4 has a current collector 41. The current collector 41 is a thin plate material or foil extending in the direction orthogonal to the layering direction. A second end portion, that is, the right end portion in FIG. 1 of the current collector 41 protrudes through a second opening 13 of the container 10 to the outside of the container 10. The second opening 13 is an opening opposite to the first opening 12 about the direction orthogonal to the layering direction. Note that the direction in which the current collector 41 protrudes is not limited to the direction opposite to the direction in which the current collector 31 protrudes.

A first surface and a second surface of the current collector 41 placed inside the container 10 are coated with an active material. The active material forms the second electrode 42. The current collector 41 is connected to the second electrode 42.

As described earlier, the first electrode sheets 3 and the second electrode sheets 4 are alternately layered. The first electrodes 32 and the second electrodes 42 are layered in the layering direction inside the container 10 with the separator 33 interposed therebetween.

The first opening 12 of the container 10 is sealed with a resin 5. The resin 5 is placed between the laminate material 11 and the current collector 31, and between the current collectors 31. Similarly, the second opening 13 is sealed with the resin 5. The resin 5 is placed between the laminate material 11 and the current collector 41, and between the current collectors 41.

The plurality of current collectors 31 are not connected inside the container 10, but individually protrude to the outside of the container 10. The plurality of current collectors 41 are also not connected inside the container 10, but individually protrude to the outside of the container 10. Since the connection space for the current collectors 31 and 41 inside the container 10 can be omitted, the area for the first electrodes 32 and the second electrodes 42 can be increased by the omitted space. As a result, the energy density of the battery cell 1 can be increased.

### (Electrode Sheet Manufacturing Method)

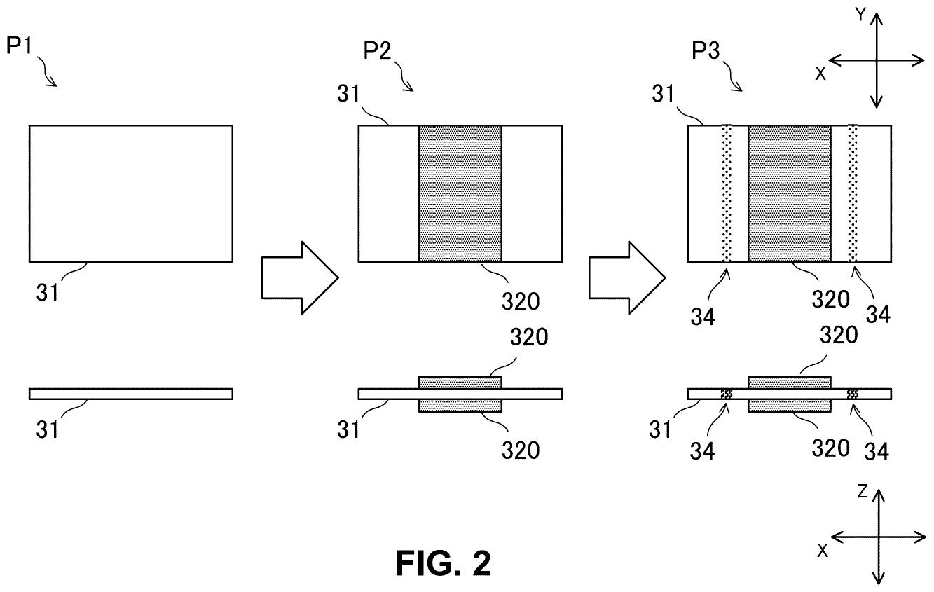

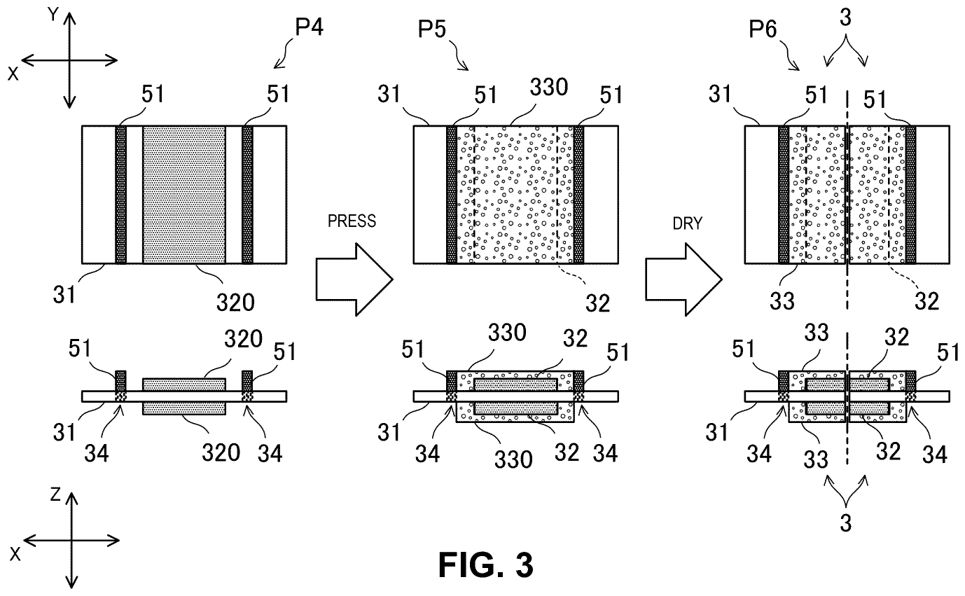

FIGS. 2 and 3 illustrate a procedure for manufacturing the electrode sheet. FIGS. 2 and 3 illustrate a procedure for manufacturing the first electrode sheet 3. Note that a procedure for manufacturing the second electrode sheet 4 is the same as the procedure for manufacturing the first electrode sheet 3, except that a fifth process P5 for forming the separator 33, described later, is omitted. That is, through holes, described later, are formed also in the current collector 41 of the second electrode sheet 4.

In a first process P1, the current collector 31 is prepared. In the case where the first electrode sheet 3 is a negative-electrode sheet, the current collector 31 is, for example, a copper foil. The current collector 31 has, for example, such a shape that is longer in the X direction than in the Y direction. The X direction is the left-right direction in the drawing plane of FIG. 2 or 3. The Y direction is the direction orthogonal to the X direction, and is the up-down direction in the drawing plane of FIG. 2 or 3. This is because, as described later, the electrode sheet is to be cut in the middle with respect to the X direction. Note that cutting in the middle is not essential for manufacturing of the electrode sheet.

In a second process P2, an active material 320 is applied to each of the first surface and the second surface of the current collector 31. The active material 320 is applied to the center portion in the X direction of the current collector 31.

In a third process P3, a plurality of through holes 34 are formed in the current collector 31. The through holes 34 penetrate the current collector 31 in the thickness direction (that is, Z direction), and open on the first surface and the second surface of the current collector 31. The through holes 34 are formed on both sides of the active material 320 interposed in the X direction and are spaced apart from the active material 320. Multiple through holes 34 are formed in the current collector 31, and the region where the through holes 34 are formed extends in the Y direction. The through holes 34 can be formed by, for example, relatively rolling a roller having pins attached thereto on the surface of the current collector 31.

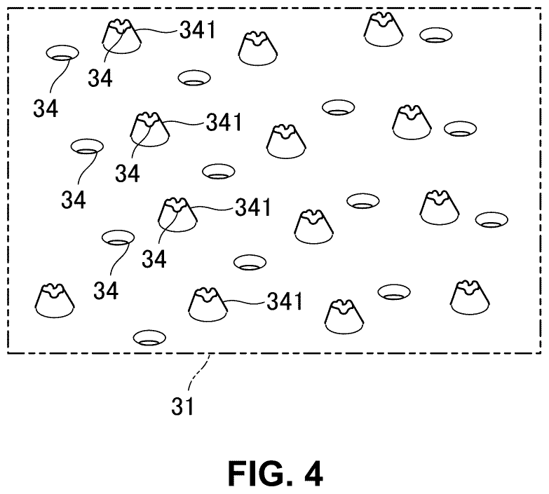

FIG. 4 shows an example of the through holes 34 formed on the current collector 31. Machining with use of pins causes burrs 341 raised from opening edges of the through holes 34 to be generated on the surface of the current collector 31. The burrs 341 serve as raised portions 341 which exert an anchoring effect, as described later, and therefore the burrs 341 are not removed from the current collector 31. In this regard, the roller is rolled on each of the first surface and the second surface of the current collector 31. With this, the burrs 341 are generated on each of the first surface and the second surface of the current collector 31.

Note that the formation of the through holes 34 may be performed before the active material 320 is applied to the current collector 31.

In a fourth process P4 of FIG. 3, a resin 51 is applied to the first surface of the current collector 31. The resin 51 is applied to the region where the through holes 34 are formed. The resin 51 forms the resin 5 that seals the openings 12 and 13 of the container 10. The resin 51 is a thermoplastic resin. The resin 51 is selected from, for example, cast polypropylene (CPP), low-density polyethylene (LDPE), liner low-density polyethylene (LLDPE), high-density polyethylene (HDPE), oriented polypropylene (OPP), polyethylene terephthalate (PET) or oriented nylon (ONY). The resin 51 is not applied to the second surface of the current collector 31. After the application of the active material 320 and the application of the resin 51 are completed, the current collector 31 is pressed by, for example, passing through a pair of rollers. The first electrode 32 is formed on each of the first surface and the second surface of the current collector 31. In addition, the resin 51 is welded on the first surface of the current collector 31.

Note that the second process P2 in which the active material 320 is applied and the fourth process P4 in which the resin 51 is applied may be exchanged. Alternatively, the application of the active material 320 and the application of the resin 51 may be performed simultaneously.

In the fifth process P5, films 330 that form the separators 33 are bonded to the current collector 31. The film 330 is bonded to at least the principal surface of the first electrode 32 on the first surface and the principal surface of the first electrode 32 on the second surface of the current collector 31. Note that the principal surface of the first electrode 32 is a surface that is opposed to the second electrode 42 with the separator 33 interposed therebetween.

Note that, in the fifth process P5, the separators 33 may be formed by application of slurry to the current collector 31. The slurry is applied to at least the principal surface of the first electrode 32 on the first surface and the principal surface of the first electrode 32 on the second surface of the current collector 31. After the application of the slurry, the slurry is dried, thereby forming the separators 33.

After each of the first electrodes 32, the resin 51, and the separators 33 is formed on the current collector 31 so that the electrode sheet is completed, the electrode sheet is cut in the middle with respect to the X direction in a sixth process P6 (see the long dashed double-short dashed line). In this manner, the two first electrode sheets 3, 3 can be produced.

### (Battery Cell Manufacturing Method)

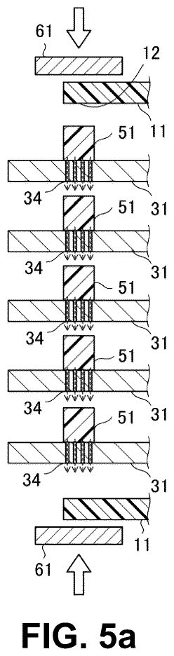

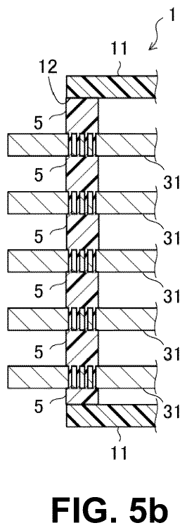

Next, with reference to FIGS. 5a and 5b, the method of manufacturing the battery cell 1 will be described. Here, although the method of manufacturing the battery cell 1 will be described taking the welding of the resin in the first opening 12 as an example, the welding of the resin in the second opening 13 is performed in a similar manner.

First, the first electrode sheets 3 and the second electrode sheets 4 are prepared. The first electrode sheet 3 has, as described earlier, the current collector 31, the first electrodes 32, the separators 33, and the resin 51. The second electrode sheet 4 has the current collector 41, the second electrodes 42, and the resin.

The first electrode sheets 3 and the second electrode sheets 4 are alternately layered. The first electrode 32 and the second electrode 42 are layered on each other with the separator 33 interposed. The power generating element 2 having the plurality of first electrode sheets 3 and the plurality of second electrode sheets 4 is formed.

As illustrated in FIG. 5a, the resin 51 is placed between the first end portion and the first electrode 32 in the current collector 31 of the first electrode sheet 3. The resin 51 is welded only on the first surface of the current collector 31. In the power generating element 2, the resins 51 are aligned in the layering direction. In addition, the resin is also placed between the second end portion and the second electrode 42 in the current collector 41 of the second electrode sheet 4.

After the power generating element 2 is formed, the power generating element 2 is covered with the laminate material 11. The edges of the laminate material 11 are, as illustrated in FIG. 5a, on the positions corresponding to the resins 51 aligned in the layering direction, and placed on the outer sides relative to the current collectors 31 that are placed on the outermost sides with respect to the layering direction. That is, in the left view of FIG. 3, the edges of the laminate material 11 are respectively placed in the position above the current collector 31 that is placed on the uppermost side and the position below the current collector 31 that is placed on the lowermost side with respect to the up-down direction. Note that the resin 51 may be provided on the edges of the laminate material 11.

Next, the resins 51 aligned in the layering direction are welded to each other. Here, the resins 51 are subjected to hot-plate welding. Specifically, as shown by the white arrows in FIG. 5a, two hot plates 61 and 61 placed on the outer sides of the laminate material 11 apply pressure and heat to the resins 51 aligned in the layering direction from the outer sides toward the center in the layering direction.

Thermal energy from the two hot plates 61 and 61 is transmitted through the laminate material 11, the resins 51, and the current collectors 31 from the outer sides toward the center in the layering direction, and the resins 51 melt by receiving the thermal energy. In this regard, as shown by the broken arrows in FIG. 5a, the melted resin 51 on the first surface flows through the through holes 34 of the current collector 31 in the layering direction, and reaches the second surface from the first surface. The resin 51 is, on the second surface, welded to the current collector 31 facing the second surface between the second surface and the current collector 31.

In this way, as illustrated in FIG. 5b, the portions between the laminate material 11 and the current collector 31 and the portions between the current collectors 31 are sealed by the resins 5 being welded in the opening (here, the first opening 12) of the container 10.

As described earlier, the current collector 31 has the through holes 34. The melted resin 51 flows in the layering direction through the through holes 34 formed in the current collector 31. Since the thermal energy is conducted by the resins 51 flowing from the outer sides toward the center in the layering direction, attenuation of the energy is reduced. In addition, since the melted resins 51 pass through the through holes 34, substantial distance of heat transfer is short. Furthermore, the heat transmission paths formed by the resins 51 are not divided by the current collectors 31, but continue from the outer sides toward the center in the layering direction. The resins 51 placed near the center in the layering direction are sufficiently supplied with the thermal energy from the hot plates 61 on the outer sides in the layering direction. All the resins 51 are sufficiently welded to the current collectors 31 or the laminate material 11. Insufficient welding of the resins 51 at the time of manufacturing of the battery cell 1 is reduced.

In addition, the electrode sheet has the resin 51 only on one side (here, the upper surface) of the current collector 31. In the group of electrode sheets layered in the layering direction, the total thickness of the resins 51 is small. Since the distance of heat transfer is short, the thermal energy is sufficiently supplied to even the resins 51 near the center in the layering direction. The quality of the battery cell 1 manufactured is stable. Note that the electrode sheet may have the resin 51 only on the lower surface of the current collector 31. Alternatively, the electrode sheet may have the resin 51 on both sides of the current collector 31.

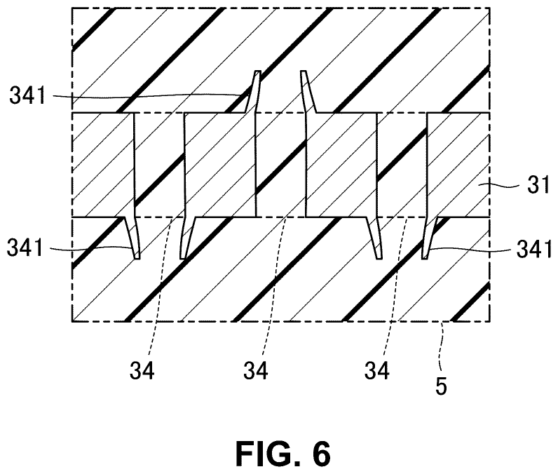

In addition, as illustrated in FIG. 6 in an enlarged manner, the burrs 341 of the current collector 31 are buried in the resin 5. The burrs, namely the raised portions 341 buried in the resin 5 enhance the strength against separation between the resin 5 and the current collector 31 due to an anchoring effect. Note that, in FIG. 6, the resin above the current collector 31 corresponds to the first resin, and the resin below the current collector 31 corresponds to the second resin. Since the burrs 341 generated at the time of machining of the through holes 34 are in a state of being buried in the resin 5 after the manufacturing of the battery cell 1, the burrs 341 do not fall off from the current collector 31. Since the burrs 341 do not serve as a contaminant in the battery cell 1, a process of removing the burrs 341 from the current collector 31 at the time of manufacturing of the electrode sheet can be omitted.

### REFERENCE SIGNS LIST

1 Battery cell
10 Container
3 First electrode sheet
31 Current collector
32 First electrode
34 Through hole
341 Burr (Raised portion)
4 Second electrode sheet
41 Current collector
42 Second electrode
5 Resin
51 Resin

1. A battery cell manufacturing method comprising:
layering electrode sheets in a layering direction, the electrode sheets each having an electrode placed in a container and a current collector that is connected to the electrode in the container and protrudes outside through an opening of the container;
applying pressure and heat to a resin placed between the current collector of one of the electrode sheets and the current collector of another one of the electrode sheets layered on the one of the electrode sheets from outer sides toward a center in the layering direction;
causing the resin to flow through through holes in the current collectors of the one of the electrode sheets and the another one of the electrode sheets in the layering direction and fill the through holes;
welding the resin between the current collector of the one of the electrode sheets and the current collector of the another one of the electrode sheets; and
sealing the opening of the container.

2. The battery cell manufacturing method according to claim 1, wherein
each of the electrode sheets has the resin bonded in advance on a first surface in the layering direction of the current collector and is free from the resin on a second surface opposite to the first surface in the layering direction, and
the resin on the first surface flows through the through hole to the second surface at the time of application of pressure and heat in the layering direction and is welded to the current collector facing the second surface between the second surface and the current collector.

3. A battery cell comprising:
a container that houses electrodes;
a plurality of current collectors that are connected to the electrodes in the container and, in a state of being layered in a layering direction, protrude outside of the container through an opening of the container; and
a resin that seals the opening of the container and is welded to the current collectors between layers thereof, wherein
the current collectors each have a first surface, a second surface opposite to the first surface in the layering direction and, in a portion interposed between a first resin being in contact with the first surface and a second resin being in contact with the second surface, at least one through hole that penetrates a respective current collector in the layering direction, and
an inside of the through hole is filled with a resin that is continuous with each of the first resin and the second resin.

4. The battery cell according to claim 3, wherein
the current collectors each have a raised portion rising from an opening edge of the through hole in at least one of the first surface and the second surface, and
the raised portion is buried in the first resin or the second resin.

5. The battery cell manufacturing method according to claim 1, wherein the resin includes a thermoplastic resin.

6. The battery cell manufacturing method according to claim 5, wherein the thermoplastic resin is one of cast polypropylene (CPP), low-density polyethylene (LDPE), liner low-density polyethylene (LLDPE), high-density polyethylene (HDPE), oriented polypropylene (OPP), polyethylene terephthalate (PET), or oriented nylon (ONY).

7. The battery cell manufacturing method according to claim 1, wherein the electrode sheets are aluminum.

8. The battery cell manufacturing method according to claim 1, wherein the electrode sheets are stainless steel.

9. The battery cell manufacturing method according to claim 1, wherein the container is a single laminate sheet folded into a bag shape.

10. The battery cell manufacturing method according to claim 1, wherein the container is formed by two laminate sheets layered together into a bag shape.

11. The battery cell according to claim 3, wherein the raised portion is a burr.

12. The battery cell according to claim 11, wherein the burr reduces separation between adjacent current collector layers.

13. The battery cell according to claim 3, wherein the resin includes a thermoplastic resin.

14. The battery cell according to claim 13, wherein the thermoplastic resin is one of cast polypropylene (CPP), low-density polyethylene (LDPE), liner low-density polyethylene (LLDPE), high-density polyethylene (HDPE), oriented polypropylene (OPP), polyethylene terephthalate (PET), or oriented nylon (ONY).

15. The battery cell according to claim 3, wherein the current collectors are aluminum.

16. The battery cell according to claim 3, wherein the current collectors are stainless steel.

17. The battery cell according to claim 3, wherein the container is a single laminate sheet folded into a bag shape.

18. The battery cell according to claim 3, wherein the container is formed by two laminate sheets layered together into a bag shape.
